(19) United States
(12) Patent Application Publication
(10) Pub. No.: US 2026/0023309 A1
(43) Pub. Date: Jan. 22, 2026

(54) DAMPING HEAD AND DAMPING MECHANISM

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/270,025

(22) Filed: Jul. 15, 2025

(30) Foreign Application Priority Data
Jul. 19, 2024 (CN) 2024217312781

(51) Int. Cl. G03B 17/56; B60R 11/04; F16F 15/02; F16F 15/04

(52) U.S. Cl. CPC G03B 17/561; B60R 11/04; F16F 15/022; F16F 15/04

(57) ABSTRACT

A damping head, including a mounting frame; a mounting piece, movably connected to the front end of the mounting frame; and a balancing assembly, including a sensing unit, multiple actuators, and multiple transmission links. Two actuators are positioned on either side of the mounting frame, with each actuator connected to a corresponding transmission link. One end of each transmission link is connected to the actuator, and the other end is connected to the mounting piece. The sensing unit is designed to detect movement of the mounting piece and transmit this information to the actuator. When a vehicle is in motion and the shooting device experiences jitter, the mounting piece deflects. The sensing unit detects this deviation and transmits it to the actuator, which then drives the transmission link to provide a counteracting damping force to the mounting piece according to the deflection angle, ensuring the stability of the shooting device.

### CROSS-REFERENCE TO RELATED APPLICATIONS

The present application for patent claims priority to and the benefit of pending Chinese Application No. 2024217312781, filed Jul. 19, 2024, and hereby expressly incorporated by reference herein as if fully set forth below in its entirety and for all applicable purposes.

### TECHNICAL FIELD

The present disclosure pertains to the technical field of camera stabilization devices, specifically to a damping head and a damping mechanism.

### INTRODUCTION

Currently, in both indoor and outdoor mobile shooting scenarios, photographers often utilize mobile shooting brackets to assist in using camera equipment for stable shooting. The shooting device is loaded onto the mobile shooting bracket, which is then fixed to a moving vehicle to track the shooting scene.

However, during shooting, road conditions can impact the damping mechanism and the camera shooting device, causing the lens to shake during movement and resulting in unstable footage.

### BRIEF SUMMARY

The present disclosure provides a damping head and a damping mechanism to enhance the stability of the equipment lens during movement.

According to some aspects of the present application, a damping head is provided, including:
a mounting frame;
a mounting piece, movably connected to the front end of the mounting frame, with the side of the mounting piece facing away from the mounting frame configured to mount a shooting device; and
a balancing assembly, including a sensing unit, multiple actuators, and multiple transmission links. Two actuators are positioned on either side of the mounting frame, with each actuator connected to a corresponding transmission link. One end of each transmission link is connected to the actuator, and the other end is connected to the mounting piece. The sensing unit is designed to detect movement of the mounting piece and transmit this information to the actuator, enabling the actuator to provide varying damping forces based on the deflection angle of the mounting piece.

### BRIEF DESCRIPTION OF THE DRAWINGS

FIG. 1 is a diagram illustrating a damping mechanism according to some aspects of the disclosure;

FIG. 2 is a diagram illustrating a damping head according to some aspects of the disclosure;

FIG. 3a is a diagram illustrating a mounting piece according to some aspects of the disclosure;

FIG. 3b is a diagram illustrating a connection part according to some aspects of the disclosure;

FIG. 4 is a diagram illustrating a mounting frame according to some aspects of the disclosure;

FIG. 5 is a diagram illustrating a brushless motor according to some aspects of the disclosure;

FIG. 6 is a diagram illustrating a damping arm according to some aspects of the disclosure;

FIG. 7 is a diagram illustrating a support assembly according to some aspects of the disclosure;

FIG. 8 is a diagram illustrating a locating piece and a strut member according to some aspects of the disclosure;

FIG. 9a is a diagram illustrating a second locking mechanism according to some aspects of the disclosure;

FIG. 9b is a cross-sectional view of the second locking mechanism of FIG. 9a;

FIG. 10 is a diagram illustrating a third locking mechanism according to some aspects of the disclosure;

FIG. 11 is a diagram illustrating a support assembly according to some aspects of the disclosure.

### REFERENCE NUMERALS

1. support assembly; 11. strut member; 12. locating piece; 121. damping connection frame; 122. vehicle connection frame; 1221. first connection frame; 1222. second connection frame; 1223. linkage rod; 1224. third locking mechanism; 1225. fourth locking mechanism; 123. second locking mechanism; 1232. sliding block; 1233. locking block; 1234. locking screw; 1235. handle grip; 124. suction cup; 125. first locking mechanism; 126. alignment connection frame; 127. fifth locking mechanism;
2. damping arm; 21. main damping arm; 22. lateral damping arm; 23. coupling mechanism; 231. first coupling link; 232. second coupling link;
3. buffer; 31. elastic element; 32. damper unit; 33. force regulator; 34. baffle ring;
4. mounting frame; 41. mounting slot; 42. display panel slot; 43. access groove; 44. cable channel;
5. mounting piece; 51. connection part; 52. mounting part; 53. connection lug; 54. outlet duct;
6. balancing assembly; 61. actuator; 611. brushless motor; 6111. motor; 6112. rotor; 6113. stator; 612. output shaft; 62. transmission link; 621. drive rod; 63. sensing unit; 631. sensor; 64. coupling link; 641. link block; 642. first pivot shaft; 643. second pivot shaft; 644. wire pass-through.

### DETAILED DESCRIPTION

To clarify the objectives, technical solutions, and aspects of the present disclosure, the following detailed description is provided in conjunction with the accompanying drawings and examples. It should be understood that the specific embodiments described herein are merely for illustrative purposes and do not limit the scope of the present disclosure. When shooting dynamic scenes with moving cameras indoors or outdoors, damping devices for imaging equipment are typically required to ensure stable and smooth footage. Currently, during shooting, road conditions can affect the damping mechanism and the shooting device, causing the lens to shake during movement and resulting in unstable footage.

The present disclosure provides a damping head and a damping mechanism. By detecting the deflection of the shooting device and utilizing an actuator 61 to provide a counteracting damping force based on the deflection angle, the jitter of the shooting device is reduced, thereby improving the stability of the equipment lens during movement.

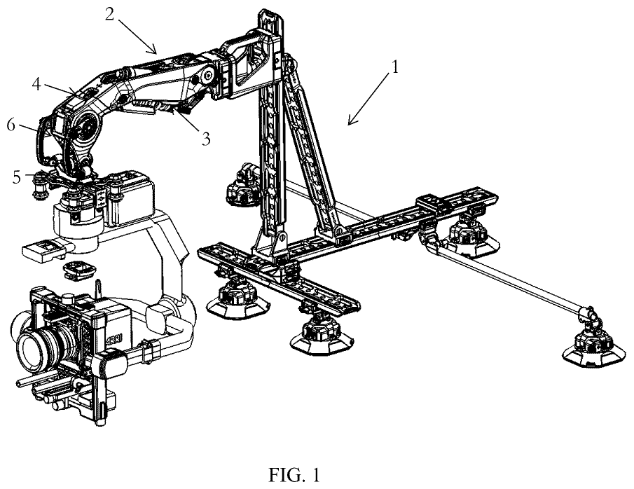

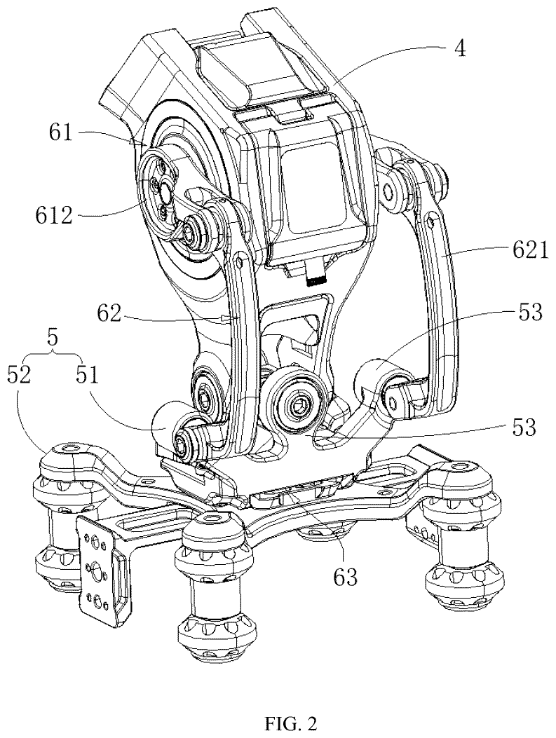

In some aspects, a damping head is provided. Referring to FIGS. 1 and 2, the damping head includes a mounting frame 4, a mounting piece 5, and a balancing assembly 6. The mounting frame 4 supports the entire damping head. The mounting piece 5 is movably connected to the front end of the mounting frame 4, with the side of the mounting piece 5 facing away from the mounting frame 4 configured to connect to the camera shooting device. The balancing assembly 6 connects the mounting frame 4 and the mounting piece 5. When the vehicle is in motion and the shooting device experiences jitter, the mounting piece 5 deflects. The balancing assembly 6 provides a counteracting damping force to the mounting piece 5 based on the deflection angle, thereby stabilizing the shooting device.

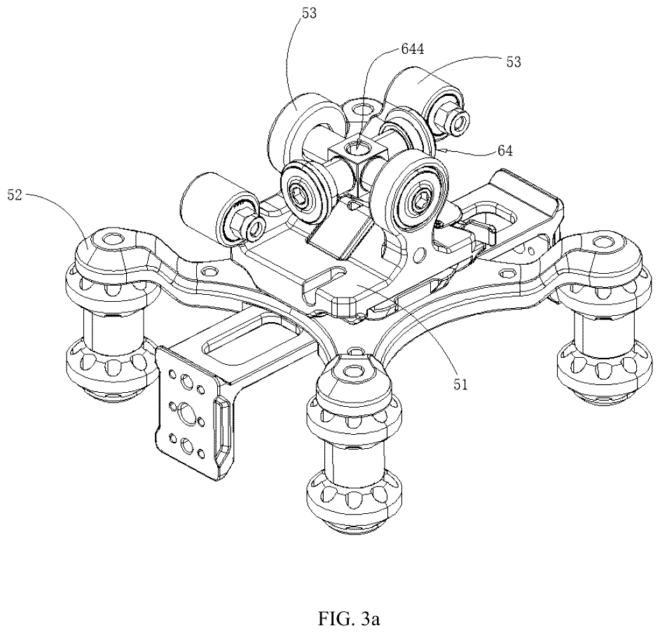

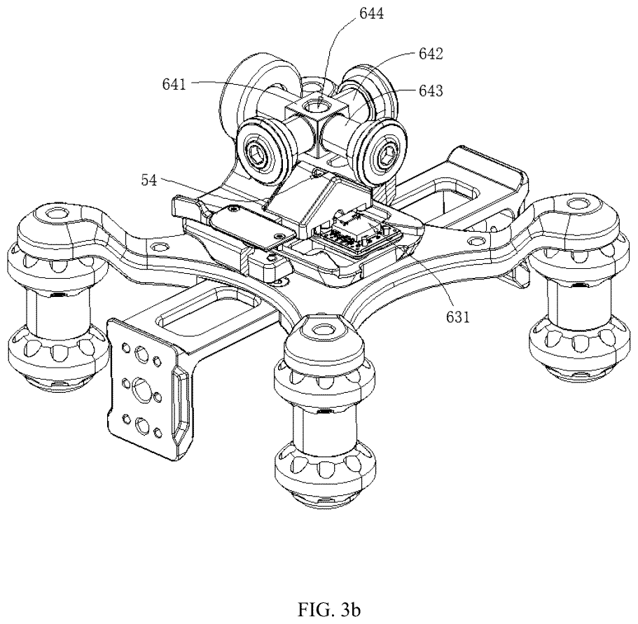

In some aspects, referring to FIGS. 2, 3a, and 3b, the balancing assembly 6 includes an actuator 61, a transmission link 62, and a sensing unit 63. The actuator 61 can be mounted on the mounting frame 4 and provides the counteracting damping force. Two sets of actuators 61 and transmission links 62 are provided, positioned on both sides of the mounting frame 4. One end of the transmission link 62 is connected to the output shaft of the actuator 61, and the other end is connected to the mounting piece 5. The sensing unit 63 detects the deviation of the mounting piece 5 and transmits this information to the actuator 61. When the shooting device jitters, both the shooting device and the mounting piece 5 deflect. The sensing unit 63 detects this deviation and transmits it to the actuator 61, which then drives the transmission link 62 to provide a counteracting damping force to balance the deviation, ensuring the stability of the shooting device.

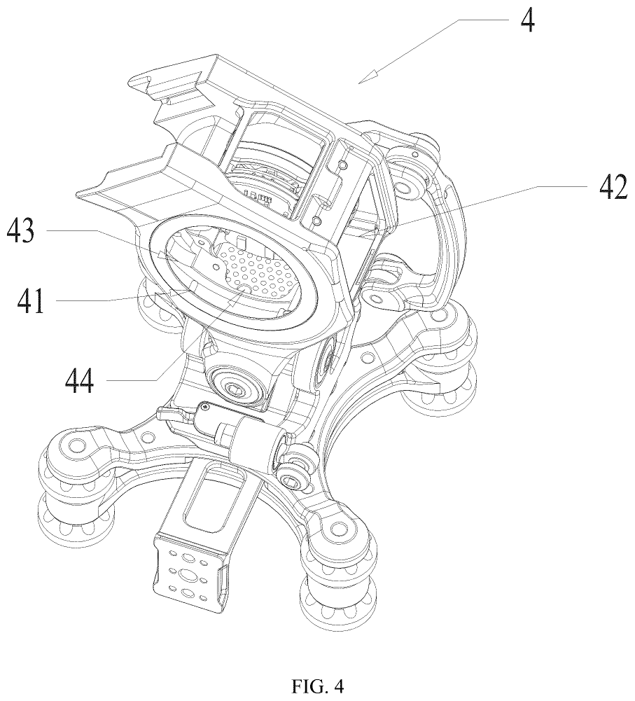

Referring to FIGS. 2 and 4, the mounting frame 4 can be a hollow frame, with its front end movably connected to the mounting piece 5. The outer wall of the mounting frame 4 is equipped with mounting slots 41 that communicate with the inner cavity of the mounting frame 4. The mounting slots 41 are used to mount the actuators 61, allowing the actuators 61 to adjust the mounting piece 5 using the damping arm 2 as support. In some aspects, the mounting frame 4 can be further equipped with a display panel slot 42 that communicates with the inner cavity for mounting a display screen.

In some aspects, referring to FIG. 2, the actuator 61 includes a brushless motor 611 and an output shaft 612. Two mounting slots 41 are provided, corresponding to the actuators 61 and positioned on both sides of the mounting frame 4. The two brushless motors 611 are mounted at the mounting slots 41, arranged opposite to each other and housed within the inner cavity of the mounting frame 4. One end of the output shaft 612 is connected to the output shaft of the brushless motor 611 and fixed relative to it, while the other end is rotatably connected to the transmission link 62. The end of the transmission link 62 facing away from the output shaft 612 is movably connected to the mounting piece 5, with the ends of two transmission links 62 facing away from the brushless motors 611 connected to different positions of the mounting piece 5 to provide counteracting damping forces at different locations.

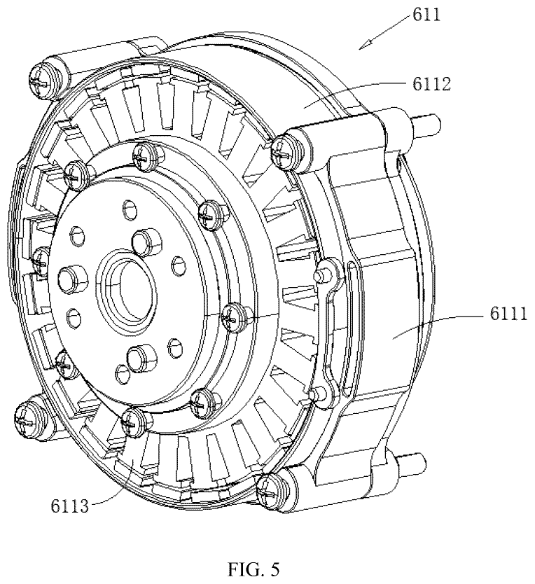

In some aspects, referring to FIGS. 2 and 5, the brushless motor 611 includes a motor body 6111, a rotor 6112, a stator 6113, and an electronic commutator (not labeled in the drawings). The motor body 6111 is mounted at the mounting slot 41. The rotor 6112 can include permanent magnets, and the stator 6113 can include coils. The electronic commutator controls the rotation direction and speed of the brushless motor 611. The stator 6113 is equipped with multiple coils. When current flows through the coils of the stator 6113, a magnetic field is generated, interacting with the magnetic field of the permanent magnets of the rotor 6112 to produce torque, thereby rotating the rotor 6112. The brushless motor 611 includes a control circuit board (not shown in the drawings), which monitors the position of the rotor 6112 in real time and adjusts the current direction and magnitude as needed to maintain synchronous rotation of the rotor 6112.

In some aspects, referring to FIG. 2, taking the perspective of facing either brushless motor 611 as an example, when the two brushless motors 611 rotate upward or downward simultaneously at the same speed, they can drive the mounting piece 5 to swing in the front-rear direction. When there is inconsistency in the rotation of the two brushless motors 611 (whether in direction or speed), the forces received at both ends of the mounting piece 5 will also differ. Consequently, the mounting piece 5 can swing in multiple directions, meaning that when the filming device deviates in different directions, the brushless motors 611 can generate corresponding damping forces to maintain a stable filming state. It is worth noting that, from the perspective of the motors themselves, since the two brushless motors 611 are symmetrical—for instance, in the front-rear direction the rotation directions of the brushless motors 611 are opposite when viewed from their own perspective.

Referring to FIGS. 2, 3a, and 3b. The mounting piece 5 can be movably connected to the mounting frame 4 through the coupling link 64, allowing the mounting piece 5 to swing in multiple directions. Specifically, the coupling link 64 includes a link block 641, a first pivot shaft 642, and a second pivot shaft 643, which are distributed along the circumference of the link block 641. The first pivot shaft 642 and the second pivot shaft 643 are perpendicular to each other. The mounting frame 4 can be rotationally connected to the link block 641 via the first pivot shaft 642, while the mounting piece 5 can be rotationally connected to the link block 641 via the second pivot shaft 643. That is, one end of the first pivot shaft 642 can be fixed to the link block 641, and the other end can be rotationally connected to the mounting frame 4. Similarly, one end of the second pivot shaft 643 can be fixed to the link block 641, and the other end can be rotationally connected to the mounting piece 5. Through the first pivot shaft 642 and the second pivot shaft 643, the mounting piece 5 can move freely in different directions without interference.

In some aspects, referring to FIG. 3b, both the first pivot shaft 642 and the second pivot shaft 643 are provided in pairs. The two first pivot shafts 642 are coaxially arranged and symmetrically positioned on both sides of the link block 641, enabling the mounting frame 4 to rotate independently on the first pivot shafts 642. The two second pivot shafts 643 are also coaxially arranged and symmetrically positioned on both sides of the link block 641, allowing the mounting piece 5 to rotate independently on the second pivot shafts 643. At the same time, the mounting frame 4 and the mounting piece 5 can rotate independently in multiple directions through their connection with the link block 641, facilitating the transmission link 62 to transmit damping forces in corresponding directions.

Referring to FIGS. 3a and 3b, the mounting piece 5 includes a connection part 51 and a mounting part 52. The connection part 51 can be movably connected to the mounting frame 4, while the mounting part 52 is used to connect the filming device. The sensing unit 63 includes a sensor 631 and a connection wire (not labeled in the drawings). The sensor 631 is positioned between the mounting part 52 and the connection part 51 to detect deviations of the filming device. The connection wire is used to electrically connect the sensor 631 to the control circuit board of the brushless motor 611, enabling the brushless motor 611 to generate counteracting damping forces. In some aspects, the sensor 631 employs a gyroscope, which is connected via the connection wire to the control circuit board of the brushless motor 611. When a deviation of the filming device on the mounting piece 5 is detected, the two brushless motors 611 are activated to operate. The rotor 6112 of the brushless motor drives the mounting piece 5 through the transmission link 62 to produce a counteracting damping force corresponding to the deviation, thereby ensuring the balance of the filming device kit.

In other aspects, other relevant products capable of detecting and sensing positional deviation of the mounting piece 5 can also serve as the sensor 631.

In some aspects, referring to FIGS. 2, 3a, and 3b, the transmission link 62 employs a drive rod 621. The upper end of the connection part 51 can be equipped with multiple connection lugs 53 for connecting the transmission link 62 and the mounting frame 4. One end of the transmission link 62 is rotationally connected to the output shaft 612, while the other end is rotationally connected to the corresponding connection lug 53. The axes of rotation at both ends of the transmission link 62 are parallel to the first pivot shaft 642. The second pivot shaft 643 is rotationally mounted on the corresponding connection lug 53 to achieve rotational connection with the mounting piece 5. The lower end of the mounting part 52 is provided with mounting structures for installing the filming device or other components. The lower end of the connection part 51 and the upper end of the mounting part 52 are designed as detachable structures, such as bolt locking or elastic locking mechanisms. In some aspects, the connection part 51 and mounting part 52 can employ other detachable structures.

In some aspects, referring to FIGS. 2, 3a, 3b, and 4. The connection part 51 is equipped with an outlet duct 54 for the connection wire to pass through. The link block 641 is provided with a wire pass-through 644 for the connection wire. The end of the mounting frame 4 near the link block 641 is furnished with a cable channel 44 that connects to the internal cavity of the mounting frame 4. One end of the connection wire is attached to the sensor, while the other end sequentially passes through the outlet duct 54, wire pass-through 644, and cable channel 44 to enter the internal cavity of the mounting frame 4, where it is electrically connected to the control circuit board of the brushless motor 611, thereby enabling signal transmission between the two. The mounting frame 4 is correspondingly provided with an access groove 43 for setting up power interface positions and communication interface mounting points.

Some aspects of the disclosure also disclose a damping mechanism, including a support assembly 1, a damping arm 2, and the aforementioned damping head connected in sequence. The support assembly 1 is used to install and support the damping mechanism. In some aspects, the support assembly 1 is designed for installation on a moving vehicle, enabling the damping arm, damping head, balancing assembly, and filming device to move collectively for filming. The damping arm 2 is movably installed at the front end of the support assembly 1. The damping arm 2 is internally equipped with a buffer 3, which absorbs and dampens loads on both sides of the damping arm 2. The damping head is positioned at the front end of the damping arm 2, i.e., the end opposite the support assembly 1, to mount and support the filming device and its associated accessories.

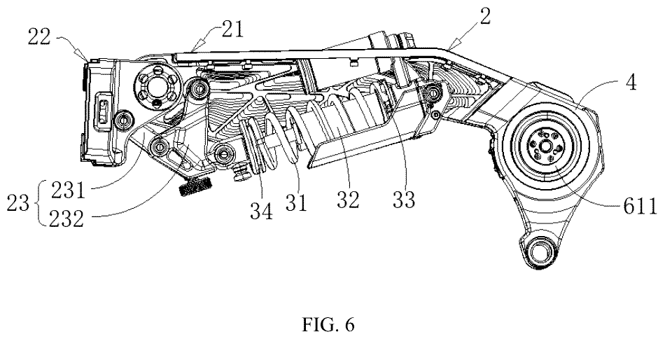

Referring to FIGS. 1 and 6, the damping arm 2 (a damping apparatus) includes a main damping arm 21 and a lateral damping arm 22. The front end of the main damping arm 21 is connected to the mounting frame 4, which is designed as a hollow frame. One end of the mounting frame 4 is installed on the damping arm 2 and serves as its housing, while the other end is movably connected to the mounting piece 5. The lateral damping arm 22 is rotationally connected to the rear end of the main damping arm 21 and interfaces with the support assembly 1. The buffer 3 includes an elastic element 31 and a damper unit 32. In some aspects, the elastic element 31 is a buffer spring, and the damper unit 32 is a damper (e.g., a shock absorber). The fixed end of the damper is rotationally connected to the front end of the main damping arm 21, while the free end (i.e., the piston rod) of the damper is rotationally installed on the lateral damping arm 22. The buffer spring is sleeved over the damper, and the elastic element 31 extends or compresses in tandem with the damper unit 32, thereby achieving damping and shock absorption.

In some aspects, referring to FIG. 6, the damper unit 32 is sleeved with a force regulator 33, which is adjustably installed on the damper. The damper is equipped with a baffle ring 34. One end of the buffer spring abuts against the baffle ring 34, while the other end abuts against the force regulator 33. By adjusting the position of the force regulator 33 on the damper, the length of the buffer spring can be controlled, thereby regulating the deformation of the elastic element 31. This enables the damping arm 2 to accommodate filming devices of varying weights, enabling quick adjustments to damping force and rebound speed based on the camera's weight. When the damping mechanism needs to adapt to equipment of different weights, there is no need to replace the spring, significantly improving applicability.

In some aspects of the present application, the force regulator 33 is threadedly connected to the damper, with its movement direction aligned along the length of the damper's piston rod. The optimal position of the force regulator 33 can be determined and adjusted based on the actual load of the filming equipment during operation.

In some aspects, referring to FIG. 6, a coupling mechanism 23 is provided between the main damping arm 21, the lateral damping arm 22, and the buffer 3. The coupling mechanism 23 is movably connected to the main damping arm 21, lateral damping arm 22, and buffer 3, forming a damping zone to reduce the displacement of the buffer 3, thereby reducing the travel of the loaded filming equipment and enhancing shooting stability.

In some aspects, referring to FIG. 6, the coupling mechanism 23 includes a first coupling link 231, which is rotatably connected to the lateral damping arm 22, and a second coupling link 232, which is rotatably connected to the main damping arm 21. The end of the first coupling link 231 away from the lateral damping arm 22 is rotatably connected to the second coupling link 232, which, in turn, is rotatably connected to the free end of the damper unit 32. The pivot shafts on the main damping arm 21, first coupling link 231, and second coupling link 232 are arranged parallel to each other. The coupling mechanism 23 forms a damping zone between the main damping arm 21, lateral damping arm 22, and buffer 3. Through the movable connection of the first and the second coupling links 231 and 232, they can swing in response to the pitch of the equipment, thereby reducing the displacement variation of the buffer 3.

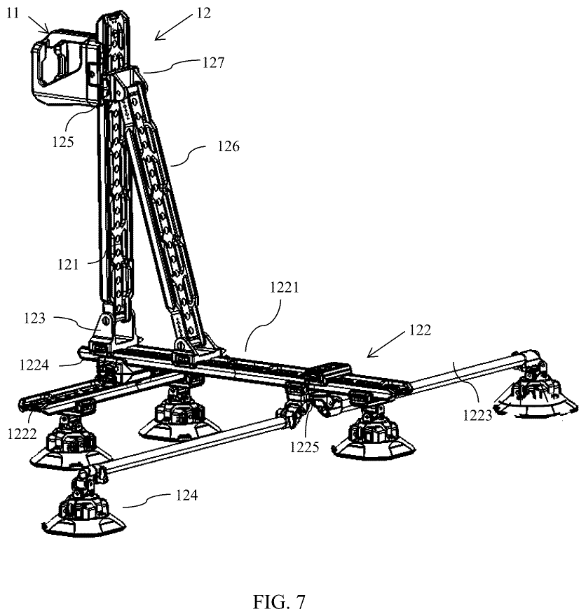

In some aspects, referring to FIGS. 1 and 7, the support assembly 1 includes a strut member 11, a first locking mechanism 125, and a locating piece 12. The strut member 11 is connected to the end of the damping arm 2 away from the mounting frame 4 and is locked with the lateral damping arm 22 to support the entire damping mechanism. The strut member 11 is adjustably mounted on the locating piece 12 via the first locking mechanism 125, and the locating piece 12 is designed for installation on a mobile vehicle.

In some aspects, referring to FIG. 7, the locating piece 12 includes a damping connection frame 121, a vehicle connection frame 122, a second locking mechanism 123, and multiple suction cups 124. The damping connection frame 121 and vehicle connection frame 122 can be locked or unlocked using the second locking mechanism 123. The suction cups 124 are adjustably connected to the damping connection frame 121 and/or vehicle connection frame 122 and are used to adhere firmly to the mobile vehicle.

Referring to FIG. 7, the vehicle connection frame 122 includes a first connection frame 1221, a second connection frame 1222, a linkage rod 1223, a third locking mechanism 1224, and a fourth locking mechanism 1225. The damping connection frame 121 is connected to the first connection frame 1221 via the second locking mechanism 123. The first and the second connection frames 1221 and 1222 are arranged in an interleaved manner, with the third locking mechanism 1224 positioned between them to connect and lock the first connection frame 1221 and second connection frame 1222 together.

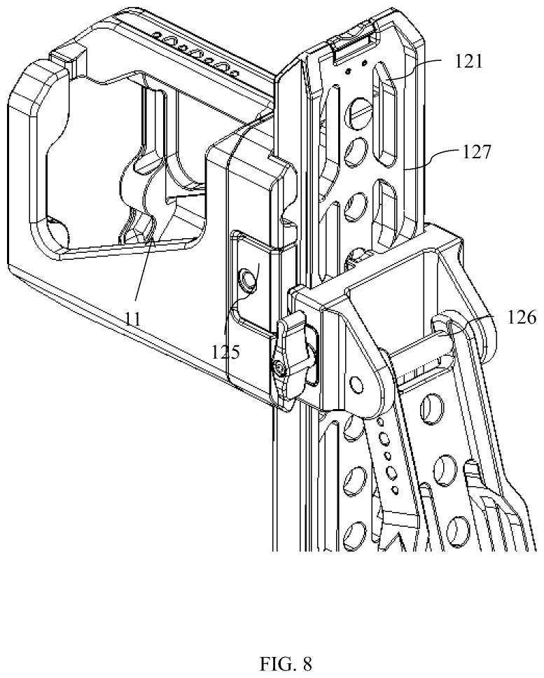

In some aspects, referring to FIGS. 7 and 8, an alignment connection frame 126 is provided between the damping connection frame 121 and the first connection frame 1221. Both ends of the alignment connection frame 126 are equipped with fifth locking mechanisms 127, which connect the two ends of the alignment connection frame 126 to the damping connection frame 121 and first connection frame 1221, respectively. In some aspects, referring to FIG. 7, the upper end of the damping connection frame 121 is connected to the strut member 11 via the first locking mechanism 125, while its lower end is hinged to the second locking mechanism 123 and connected to the first connection frame 1221 via the second locking mechanism 123, allowing angular adjustment between the damping connection frame 121 and the first connection frame 1221. The fifth locking mechanism 127 is hinged to both ends of the alignment connection frame 126, which are then locked to the damping connection frame 121 and first connection frame 1221 via the second locking mechanism 123, forming a stable triangular structure among the damping connection frame 121, the first connection frame 1221, and the alignment connection frame 126 to reinforce the support of the strut member 11.

In some aspects, referring to FIG. 7, the fourth locking mechanism 1225 is connected to the end of the first connection frame 1221 away from the second connection frame 1222. Two linkage rods 1223 are provided, with one end hinged to the fourth locking mechanism 1225 and connected to the first connection frame 1221 via the fourth locking mechanism 1225, while the other end connects to suction cups 124 that adhere to the vehicle surface. Additional suction cups 124 can be distributed on the first and the second connection frames 1221 and 1222. The suction cups 124 are electrically powered for stable adhesion, although their placement may vary (e.g., on the damping connection frame 121) based on installation needs in other examples. The suction cups 124 and linkage rods 1223 offer flexible positioning to reinforce the support assembly 1.

In some aspects, referring to FIG. 7, the upper end of each suction cup 124 is movably connected to the fourth locking mechanism 1225 and locked onto the first and the second connection frames 1221 and 1222 via the fourth locking mechanism 1225, while the lower end adheres for positioning, allowing angular adjustment according to the surface.

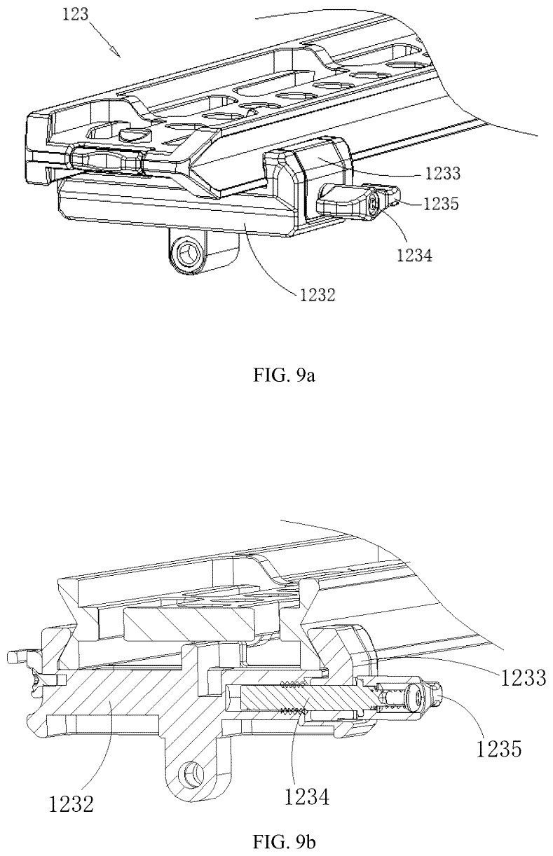

In some aspects, referring to FIGS. 7, 9a, and 9b, the first, second, third, fourth, and fifth locking mechanisms 125, 123, 1224, 1225, and 127 share the same locking principle in some examples. Taking the second locking mechanism 123 as an example, it includes a sliding block 1232, a locking block 1233, and a locking screw 1234. The sliding block 1232 has a locking groove that fits over the first connection frame 1221, allowing the damping connection frames 121 and 122 to slide along the locking groove for positional adjustment. The groove includes guide portions near the sidewalls of the first connection frame 1221, with slots to accommodate the locking block 1233 for directional guidance along the locking direction. The locking screw 1234 passes through the locking block 1233 and threads into the sliding block 1232, with clearance fit between them. Rotating the locking screw 1234 drives the locking block 1233 toward the first connection frame 1221 to clamp the first connection frame 1221. A handle grip 1235 is externally attached to the locking screw 1234 for manual operation. The side of the sliding block 1232 away from the groove serves as a connection point for hinging the lower end of the damping connection frame 121 or attaching other components.

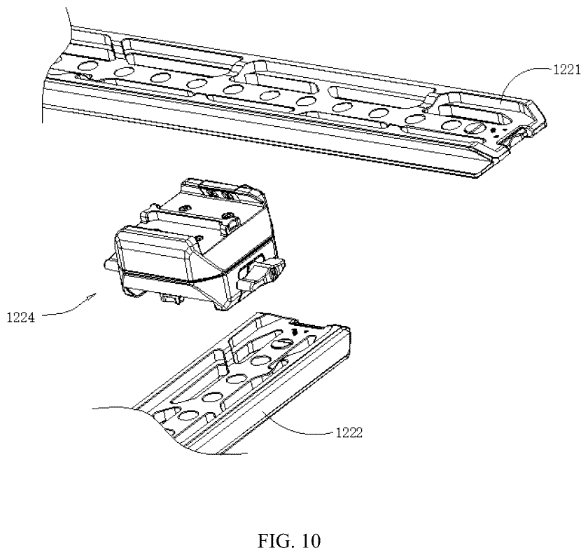

In contrast to the previously described locking structures, referring to FIG. 10, the third locking mechanism 1224 can be constructed by stacking two sets of locking slots from the second locking mechanism 123 in a back-to-back configuration. The outer sides of these two locking slots are bolted together to form a unified whole, and each of the two outward-facing locking grooves is connected to the first connection frame 1221 and the second connection frame 1222, respectively, to establish their connection.

In some aspects, referring to FIGS. 9a and 9b, both sides of the damping connection frame 121 and the vehicle connection frame 122 are equipped with beams featuring sloped outer surfaces. The adjacent sides of the locking blocks 1233 are correspondingly designed with inwardly sloped surfaces that align with the beams, enabling the clamping and securement of the damping connection frame 121 and the vehicle connection frame 122.

Referring to FIGS. 7 and 8, the strut member 11 is structured as a frame, with one end bolted and fixed to the lateral damping arm 22 and the other end connected to the first locking mechanism 125 through a connection part. This configuration allows the strut member to be adjustably mounted on the damping connection frame 121 via the first locking mechanism 125. When adjusting the filming device, the strut member 11 can slide along the damping connection frame 121 to adjust the position of the damping arm 2 and subsequently be locked and fixed by the first locking mechanism 125. Thereafter, the adjustable connection between the damping connection frame 121 and the first connection frame 1221 accommodates adjustments to the vehicle's mounting surface. Positioning is then achieved through the alignment connection frame 126, resulting in a flexible yet stable support structure.

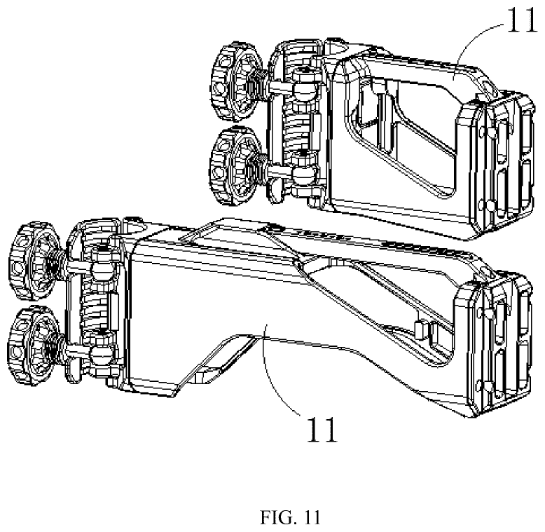

Referring to FIG. 11, in some aspects, the suction cup 124 is utilized to adhere to and be positioned on the surface of a moving vehicle. In other examples, the strut member 11 can also incorporate other locating pieces 12 and can be configured with various common mounting interfaces used for photographic equipment, depending on the mounting location, such as pipe clamps, ¼ threaded interfaces, ⅜ threaded interfaces, etc., for locking onto column mounts. The specific positioning structure can be tailored according to the on-site installation conditions.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A damping head, comprising:
a mounting frame;
a mounting piece movably connected to a front end of the mounting frame, wherein a side of the mounting piece facing away from the mounting frame is configured for mounting a shooting device; and
a balancing assembly comprising a sensing unit, multiple actuators, and multiple transmission links, wherein each of the actuators is respectively provided on a corresponding side of the mounting frame, each of the actuators is correspondingly connected to one transmission link, one end of the transmission link is connected to the actuator, and another end is connected to the mounting piece;
wherein the sensing unit is configured to detect movement of the mounting piece and transmit movement information to the multiple actuators; and
wherein, the multiple actuators provide varying damping forces based on a deflection angle of the mounting piece.

2. The damping head according to claim 1, wherein the mounting frame is provided with a mounting slot on an outer wall of the mounting frame;
wherein each of the actuators comprises a brushless motor and an output shaft;
wherein the brushless motor is provided at the mounting slot;
wherein one end of the output shaft is connected to an output shaft of the brushless motor, and another end is movably connected to the corresponding transmission link; and
wherein the corresponding transmission link is drivingly connected to the mounting frame at an end opposite to the output shaft, enabling the actuator to adjust the mounting frame.

3. The damping head according to claim 2, wherein the brushless motor comprises a rotor and a stator;
wherein the rotor comprises a plurality of permanent magnets;
wherein the stator comprises a plurality of coils;
wherein in response to a current flowing through the plurality of coils, a magnetic field is generated; and
wherein a plurality of permanent magnets of the rotor produce torque under the magnetic field, causing the rotor to rotate.

4. The damping head according to claim 1, wherein the mounting piece is movably connected to the mounting frame via a coupling link;
wherein the coupling link comprises a link block, a first pivot shaft, and a second pivot shaft, the first pivot shaft and the second pivot shaft distributed circumferentially around the link block;
wherein the mounting frame is rotatably connected to the link block via the first pivot shaft; and
wherein the mounting piece is rotatably connected to the link block via the second pivot shaft.

5. The damping head according to claim 4, wherein the mounting piece further comprises a connection part and a mounting part;
wherein the connection part is movably connected to the mounting frame via the second pivot shaft;
wherein the mounting part is configured for connecting a shooting device;
wherein the sensing unit comprises a sensor; and
wherein the sensor is provided between the mounting part and the connection part to detect tilt of the shooting device.

6. The damping head according to claim 5, wherein the link block is provided with a wire pass-through for routing connecting wires;
wherein the mounting frame is configured with a cable channel at an end adjacent to the link block; and
wherein a cable channel communicates with an inner cavity of the mounting frame.

7. A damping mechanism, comprising:
the damping head according to claim 1;
a damping arm provided at a rear end of the damping head, wherein the damping arm is internally provided with a buffer, and the buffer is configured to absorb and dampen energy from a load; and
a support assembly disposed at a rear end of the damping arm, the support assembly comprising a strut member, a first locking mechanism, and a locating piece, wherein the strut member is configured to connect and support the damping arm; and
wherein the strut member is adjustably provided on the locating piece via the first locking mechanism, and the locating piece is configured to be configured on a moving vehicle.

8. The damping mechanism according to claim 7, wherein the locating piece comprises a damping connection frame, a vehicle connection frame, a second locking mechanism, and multiple suction cups;
wherein the damping connection frame and the vehicle connection frame are configured to unlocked or locked via the second locking mechanism; and
wherein the suction cups are adjustably connected to the damping connection frame and the vehicle connection frame, and the suction cups are configured to be affixed on the moving vehicle.

9. The damping mechanism according to claim 7, wherein the locating piece comprises a damping connection frame, a vehicle connection frame, a second locking mechanism, and multiple suction cups;
wherein the damping connection frame and the vehicle connection frame are configured to unlocked or locked via the second locking mechanism; and
wherein the suction cups are adjustably connected to the damping connection frame or the vehicle connection frame, and the suction cups are configured to be affixed on the moving vehicle.

10. The damping mechanism according to claim 8, wherein the vehicle connection frame comprises a first connection frame, a second connection frame, a linkage rod, a third locking mechanism, and a fourth locking mechanism;
wherein the damping connection frame is connected to the first connection frame via the second locking mechanism;
wherein the first connection frame and the second connection frame are arranged in a staggered manner;
wherein the third locking mechanism is disposed between the first connection frame and the second connection frame to connect and lock the first connection frame and the second connection frame;
wherein the fourth locking mechanism is connected to an end of the first connection frame away from the second connection frame, and at least one linkage rod is movably connected to a side opposite to the first connection frame; and
wherein each of the suction cups comprises a first part, a second part, and a third part, the first part is connected to the linkage rod, the second part is connected to the second connection frame, and the third part is connected to the first connection frame.

11. The damping mechanism according to claim 10, wherein an alignment connection frame is disposed between the damping connection frame and the first connection frame;
wherein each end of the alignment connection frame is provided with a fifth locking mechanism; and
wherein each end of the alignment connection frame is connected to the damping connection frame and the first connection frame via the fifth locking mechanism respectively.
